(19) United States
(12) Patent Application Publication
(10) Pub. No.: US 2005/0199041 A1
(43) Pub. Date: Sep. 15, 2005

(54) Sensor assembly for measuring a gas concentration

(75) Inventors: Heribert Weber, Nuertingen (DE); Christian Krummel, Kirchentellinsfurt (DE)

Correspondence Address: THE FIRM OF KARL F ROSS, 5676 RIVERDALE AVENUE, PO BOX 900, RIVERDALE (BRONX), NY, 10471-0900, US

(73) Assignee: PARAGON AG, Dellbruck (DE)

(21) Appl. No.: 10/514,211

(22) PCT Filed: Nov. 14, 2002
(86) PCT No.: PCT/DE02/04207

§ 371 Date: Nov. 9, 2004

(30) Foreign Application Priority Data
May 11, 2002 (DE) 102 21 084.5

(51) Int. Cl. G01N 27/02

(52) U.S. Cl. 73/31.06

(57) ABSTRACT

The invention relates to a sensor assembly for measuring a gas concentration, in particular CO, H₂, NOₓ and/or hydrocarbons. The aim of the invention is to permit an accurate measurement by relatively simple means, ii particular at low cost. To achieve this, the sensor assembly is provided with an insulation material that is applied to the substrate (2) and comprises one or more insulation layers (4, 6, 8, 10), at least one first electrode structure (12, 13) that is provided in or on the insulation material, at least one second electrode structure (14, 15) that is provided in or on the insulation material and is placed at a vertical distance from the first electrode structure, a gas-sensitive layer (16), which borders the first electrode structure (12, 13) and the second electrode structure (14, 15) and a heating conductor structure (7) that is located in the insulation material (4, 6, 8, 10).

The invention relates to a sensor assembly [arrangement] for the measurement of a gas concentration, especially the concentration of carbon monoxide (CO), hydrogen (H₂), a nitrogen oxide (Noₓ) and/or a hydrocarbon. Integrated sensor assemblies with a high sensitivity for these gases have, as a rule, a gas-sensitive layer of metal oxide which can be heated to a temperature of, for example, several hundred degrees Celsius by means of heater conductor structures, and is evaluated electrically by electrode structures usually with resistive measurements.

For this purpose it has been customary to laterally structure such electrode layers to obtain an interdigitating finger structure in which the two electrodes interengage in a comb-like manner. The gas-sensitive layer is then provided in a meander pattern between the comb-like interdigitating fingers of the electrodes so that because of the large areas of the electrodes a low overall resistance is obtained between the electrodes.

To this end, for an inexpensive fabrication with less material and low spatial requirements, a high degree of integration is desired. Furthermore, with smaller dimensions of the gas-sensitive layer between the electrodes, the number of grain boundaries within the gas-sensive material; is reduced so that a more precise measurement is possible.

The spacing between the electrodes is determined by the structural precision of the semiconductor process used. With known μ-mechanics this structuring precision lies above 1 μm; with CMOS processes the structuring precision lies below 1 μm. A higher level of integration is, however, obtainable only with difficulty. By means of “writing” methods, for example with electron beam exposures, it is possible to realize structuring widths significantly below 1 μm; such processes are however operationally expensive and costly.

The sensor arrangement in accordance with the invention with the features of claim 1 offers the advantage, by contrast with the prior art, especially that it enables at a relatively reduced is cost and especially also inexpensively the fabrication of the sensor assembly and therefore precise measurements from its use. Advantageously in this manner multi-parameter sensor signals can be recovered.

Thus, according to the invention, the electrodes are configured as electrode layers mutually spaced vertically from one another. In this manner, their contact spacings are determined by the layer thicknesses of the one or more insulating layers lying between them. As a result, using current techniques like, for example, CVD [chemical vapor deposition], PVD [plasma-assisted vapor deposition] or the like, layer thicknesses and thus electrode spacings of several nm [nanometers] can be realized. Through the vertical structuring according to the invention, significant drawbacks of the conventionally only laterally structured sensor arrangements can be completely or partly avoided and small contact spacings can be achieved at relatively little cost with conventional technologies. Thus a high degree of integration with low spatial requirements and reduced material cost can be obtained. Furthermore, advantageous nanostructured materials can be used for the gas-sensitive layer such that only individual crystallites or only a single crystallite will lie between the electrodes, thereby achieving better measurement characteristics, especially as concerns sensitivity and the selectivity as to the gases measured and the gas concentration ranges. Based upon reduced layer thicknesses of the gas-sensitive layer obtainable, which nevertheless has a greater surface area with respect to the gas volume to be measured, a good dynamic response behavior can be achieved.

A further advantage according to the invention is that, in addition to the vertical structuring, a lateral structuring can be provided. As a result, a higher degree of integration with reduced spatial requirements can be achieved. Through the additional application of further electrode layers, the precision of the measurement can be increased; especially the selectivity can be increased by a comparison of the different signals and additional data, especially with respect to the state of the sensor and for example its age and the degree of poisoning, can be obtained.

By the provision of a free space in a central region of the substrate, a membrane can be provided which is largely decoupled from the substrate in a thermal sense and can be formed from the insulation layers, the gas sensitive layer, the electrodes and the heat conductor structure. The insulation layers can be composed for example of silicon nitride (Si₃N₄) silicon oxide, silicon oxynitride, silicon carbide or combinations of these materials, whereby an inexpensive configuration of a membrane maintained under tension can be achieved. As an alternative to the formation of a free space in the substrate, the thermal insulation can be achieved also by providing a hollow in the substrate or through the use of a layer of porous substrate, for example porous silicon.

The invention is described in greater detail with reference to the accompanying drawing in connection with several embodiments. The drawing shows:

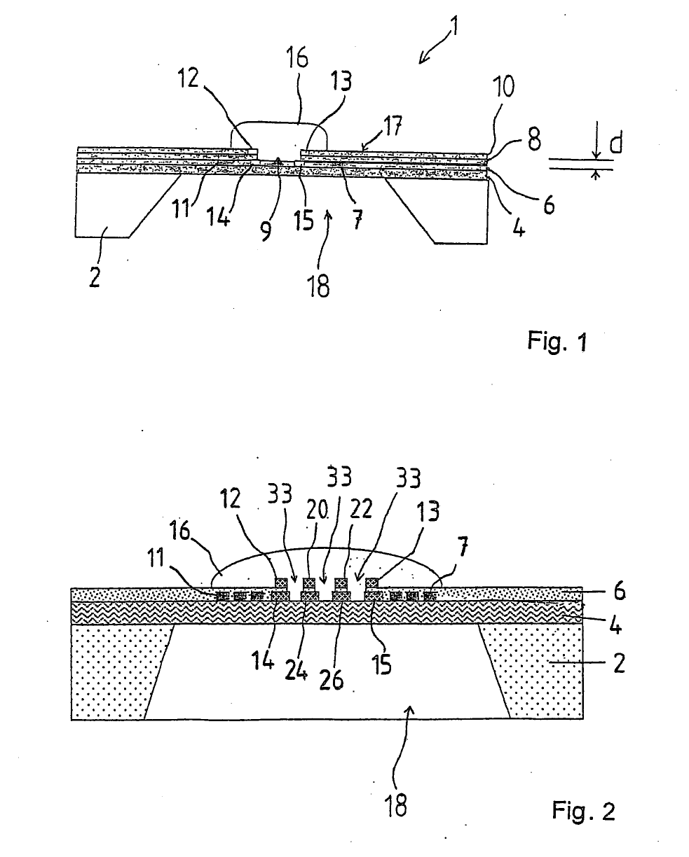

FIG. 1—a vertical section through a sensor assembly according to one embodiment of the invention;

FIG. 2—a vertical section through a sensor assembly according to a further embodiment of the invention;

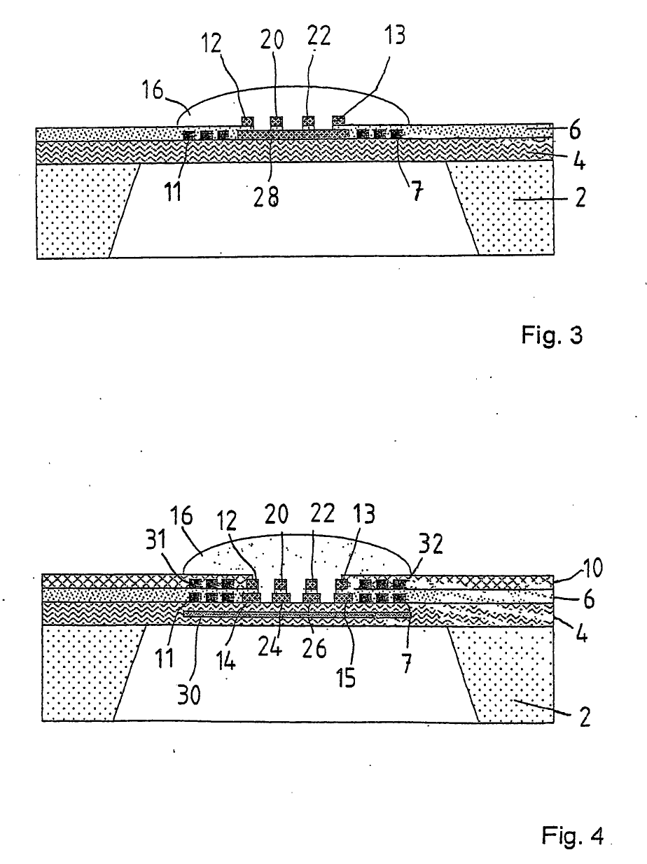

FIG. 3—a vertical section through a sensor assembly according to a further embodiment of the invention;

FIG. 4—a vertical section through a sensor assembly according to a further embodiment of the invention.

According to FIG. 1, a first insulation layer 4, a second insulation layer 6, a third insulation layer 8 and a fourth insulation layer 10 are formed on a silicon substrate 2. In the second insulation layer 6 and spaced apart from one another in the lateral direction, a left and right second electrode structure 14, 15, for example of a metal, which extend in the longitudinal direction parallel to one another, are provided. Laterally outside the two electrode structures, heat conductor structures 7, 11 are provided. By means of the third insulating layer 8 a left and right first electrode structure 12, 13 are separated from the second electrode structure and provided in the fourth insulating layer 10.

As shown in FIG. 1, in the third and fourth insulating layers a recess 9 is provided which partly exposes the electrode structures 12, 13, 14, 15. A gas sensitive layer 16 of, for example, a metal oxide, covers this recess and a part of the surface of the fourth insulating layer 10 and the entire electrode structure can be covered or enclosed with respect to the exterior. Because of the symmetrical arrangement of the heat conductor structure 7 and 11 a uniform heating for the central region with the electrodes and the gas sensitive layer can be achieved. For thermal decoupling a free space 18 is provided in the substrate 2 so that the central region forms a membrane 17. A vertical spacing (d) between the first electrode structures 12, 13 and the second electrode structures 14, 15 in the example shown amounts to 2 mm through 10 μm, for example about 1500 nm or in the case of nanostructured gas sensitive layer 16, several nm.

FIG. 2 shows a further embodiment in which on the first insulation layer 4 laterally outwardly to the left and right, respective heat conductive structures 7, 11 are applied and which are covered by the second insulating layer 6. Between the heat conductor structures 7, 11, four parallel second electrode structures 14, 24, 26 15 are applied to the first insulating layer 4 and are covered on their upper sides each by the second insulating layer 9. On the second insulating layer 6, four parallel first electrode structures 12, 20, 22, 13 are applied, each above one of the second electrode structures. In the second insulating layer 6 a respective recess 33 is provided between each two neighboring second electrode structures and is filled with the gas sensitive layer 16 so that each first and second electrode structure is bounded by the gas sensitive layer 16.

The embodiment shown in FIG. 3 differs from the embodiment of FIG. 2 in that a second electrode structure 28 extending in the lateral direction below the four first electrode structures is provided in the second insulating layer 6.

In the embodiment of FIG. 4 differentiating from the embodiment of FIG. 2, an upper insulating layer 10 is applied on the second insulating layer 6 and, in that upper insulating layer 10, laterally outer heat conductor structures 31 and 32 are formed above the heat conductor structures 7, 11. The upper insulating layer 10 borders on the laterally outermost first electrode structures 12 and 13 whereby all of the first and second electrode structures are bounded by the gas sensitive layer 16. Furthermore, in the first insulating layer 4 a third electrode 30 is provided which extends in the lateral direction over at least the first and second electrode structures and is not bounded by the gas sensitive layer 16.

The sensor arrangements illustrated in the figures can be actuated, depending upon the material used for the gas sensitive layer 16, by means of a direct current voltage source resistively or by means of an alternating current source for capacitive measurements or impedance measurements. In this manner a voltage can be applied between the first and second electrode structures between which in the vertical direction there is only the small distance d so that only a few or even only a single crystallite of the gas sensitive layer 16 can be disposed between the electrodes.

In the embodiments of FIGS. 2 to 4 with several first electrode structures, the surface area of the transition between the first and second electrode structures, i.e. the interfaces, is greater than in the embodiment of FIG. 1 so that a signal of greater magnitude is recovered. In addition according to the invention, alternatively or in addition to the vertical measurement, a lateral measurement of the ohmic resistance, the capacitance, and/or the impedance between the laterally spaced first electrode structures and/or between the laterally spaced second electrode structures is possible. In the embodiment of FIG. 1 there thus can be obtained a direct measurement between the electrode structures 12 and 13 whereas in the embodiments of FIGS. 2 to 4, respective four point resistive measurements can be obtained with the four laterally spaced electrode structures, following the application of a voltage between the laterally outermost electrode structure 12 and 13 or 14 and 15 and the voltage drop measured at the central electrode structure 20 and 22 or 24 and 26.

The third electrode layer or structure 30 shown in the embodiment of FIG. 4 can be provided correspondingly also in the embodiments of FIGS. 1 to 3. By applying a voltage between the third electrode structure and the first and/or second electrode layers or electrode structure, an electronic field can be coupled into the gas sensitive layer 16 to influence the sensor effect by resistive, capacitance or impedance measurement in vertical or lateral made in a targeted manner.

1. A sensor assembly for measuring a gas concentration especially of carbon monoxide, hydrogen, and/or hydrocarbons, with
an insulation material provided on a substrate (2) that has one or more insulation layers (4, 6,8, 10),
a first electrode structure (12, 13, 20, 22) in or on the insulation material,
a second electrode structure (14, 15, 24, 26, 28) provided in or on the insulation material and spaced from the first electrode structure in the vertical direction,
a gas sensitive layer (16) bounded on the first electrode structure (12, 13, 20, 22) and the second electrode structure (14, 15, 24, 26, 28) and
a heating conductor structure (7, 11, 31, 32) provided in the insulation material (4, 6, 8, 10).

2. A sensor assembly according to claim 1 and characterized in that an electrical resistance, a capacitance and/or an impedance of the gas sensitive layer 16 depends from the gas concentration.

3. A sensor assembly according to claim 1 characterized in that two, three, four or more first electrode structures (12, 13, 20, 22) are provided in spaced apart relationship from one another in the lateral direction and border on the gas sensitive (16) layer.

4. The sensor assembly according to claim 1 characterized in that two, three, four or more first electrode structures (14 15, 24, 26) are provided spaced from one another in the lateral direction and against which the gas sensitive layer (16) borders.

5. The sensor assembly according to claim 1 characterized in that a thoroughgoing second electrode structure (28) is provided against which the gas sensitive layer (16) abuts.

6. The sensor assembly according to claim 3 characterized in that the plurality of first electrode structures and/or the plurality of second electrode structures are connected with different contact terminals.

7. The sensor assembly according claim 1 characterized in that at least two heat conductor structures (7, 11, 31, 32) are provided in an insulation layer (6, 10) in laterally spaced relationship and are arranged symmetrically to the electrode structures and the gas sensitive layer (16).

8. The sensor assembly according to claim 1 characterized in that in the substrate (2) a free space 18 is formed above which a membrane is provided from the insulating material (4, 6, 8, 10), the electrode structures (12, 13, 20, 22, 14, 15, 24, 26, 28, 30) and the gas sensitive layer (16) and preferably also the heat conductor structures (7, 11, 31, 32).

9. The sensor assembly according to claim 1 characterized in that in the region of the electrode structures (12, 13, 20, 22, 14, 15, 24, 26, 28, 30) the gas sensitive layer (16) and preferably also the heat conductor structures, below the insulation material (4, 6, 8, 10) a layer of porous substrata, preferably porous silicon, is formed.

10. The sensor assembly according to claim 1, characterized in that in the vicinity of the electrode structures (12, 13, 20, 22, 14, 15, 24, 26, 28, 30), the gas sensitive layer (16) and preferably also the heat conductor structure, has a hollow formed in the substrate.

11. The sensor assembly according to claim 1 characterized in that on the substrate (2), at least a first insulating layer (4), a second insulating layer (6) containing the second electrode structure (14, 15), an insulating layer (8) separating the first and second electrode structures and a fourth insulating layer 10 containing the first electrode structure (12, 13) are provided one above another, whereby in at least the third and fourth insulating layers a recess (9) is formed in which the gas sensitive layer 16 is applied.

12. The sensor assembly according to claim 1 characterized in that a first insulating layer (4) and a second insulating layer (6) containing the second electrode structure (14, 15, 24, 26, 28) are provided one above the other on the substrate (2) whereby the first electrode structure (12, 13, 20, 22) is deposited upon the second insulating layer above the second electrode structure (14, 15, 24, 26, 28) and at least one recess is formed in the second insulating layer (6) in which a gass sensitive layer (16) is applied.

13. The sensor assembly according to claim 1 characterized in that at least a third electrode structure (30) is provided and is spaced in the lateral direction from the first electrode structure and the second electrode structure in the lateral structure.

14. The sensor assembly according to claim 1 characterized in that the first electrode structure and/or the second electrode structure is comb like in the lateral direction or interdigitate with one another with teeth, whereby the gas sensitive layer (16) is provided between them.

15. The sensor assembly according to claim 1 characterized in that the insulating layers (4, 6, 8, 10) are under tension stress in the lateral direction.

16. The sensor assembly according to claim 1 characterized in that the insulating material of silicon nitride (Si₃N₄) silicon oxide, silicon oxynitride, silicon carbide or combinations thereof.

17. The sensor assembly according to claim 1 characterized in that between the first electrode structures (12, 13, 20, 22) and the second electrode structures (14,15, 24, 26, 28) a vertical spacing of 2 nm to 10 μm is provided.

18. The sensor assembly according to claim 1 characterized in that the sensor assembly of the gas sensitive layer (16) is nanostructured, preferably with a grain size of 10 to 50 nm.

19. Method of measuring a gas concentration using a sensor arrangement according to claim 1 characterized in that selectively between the first and second electrode structures and/or between different first electrode structures and/or between different second electrode structures a direct current voltage or alternating current voltages apply and an ohmic resistance and/or a capacitance and/or impedance of the gas sensitive layer (16) is measured.

20. The method using a sensor arrangement with first and/or second electrode structures according to claim 3 characterized in that an ohmic resistance is measured by a four point measurement in that at the first and fourth electrode structures (12, 13; 14, 15) a direct current is applied and at the intermediate electrode structure (20, 22; 24, 26) a voltage drop is measured.

21. The method using a sensor assembly according to claim 13 characterized in that between the third electrode and the first and/or electrode structure a voltage is applied.
